(19) United States
(12) Patent Application Publication
(10) Pub. No.: US 2017/0121160 A1
(43) Pub. Date: May 4, 2017

(54) Forklift System

(71) Applicant: Stan Roberts, Ely, NV (US)

(72) Inventor: Stan Roberts, Ely, NV (US)

(21) Appl. No.: 14/927,136

(22) Filed: Oct. 29, 2015

(51) Int. Cl. B66F 9/08; B66F 9/12

(52) U.S. Cl. CPC B66F 9/08; B66F 9/12

(57) ABSTRACT

A forklift system includes a vehicle that has a front end. A winch is coupled to the vehicle and a forklift is removably coupled to the vehicle. The fork lift is positioned on the front end such that the forklift may engage an object. Thus, the vehicle may transport the object. The forklift is operationally coupled to the winch such that the forklift may selectively lift and lower the object with respect to a support surface.

### BACKGROUND OF THE DISCLOSURE

### Field of the Disclosure

The disclosure relates to forklift devices and more particularly pertains to a new forklift device for equipping an ATV to transport a heavy object.

### SUMMARY OF THE DISCLOSURE

An embodiment of the disclosure meets the needs presented above by generally comprising a vehicle that has a front end. A winch is coupled to the vehicle and a forklift is removably coupled to the vehicle. The fork lift is positioned on the front end such that the forklift may engage an object. Thus, the vehicle may transport the object. The forklift is operationally coupled to the winch such that the forklift may selectively lift and lower the object with respect to a support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a forklift system according to an embodiment of the disclosure.

FIG. 2 is a front view of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

### DESCRIPTION OF THE PREFERRED EMBODIMENT

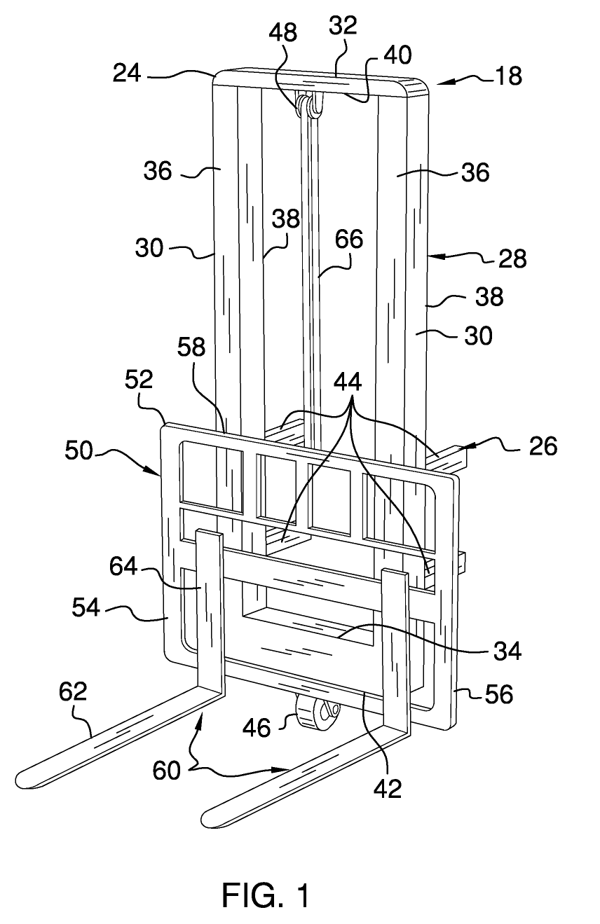

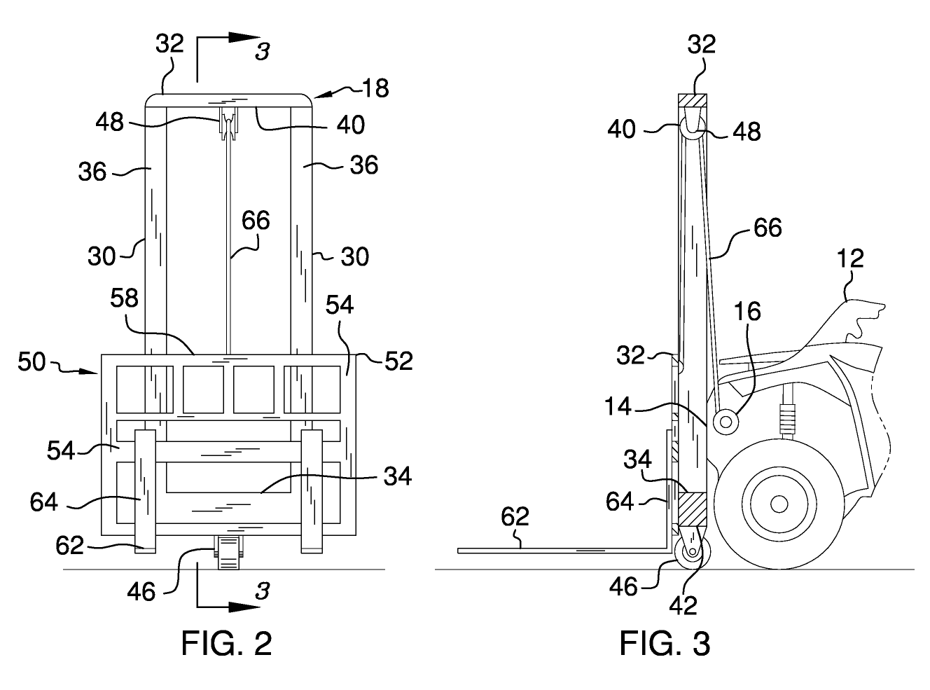

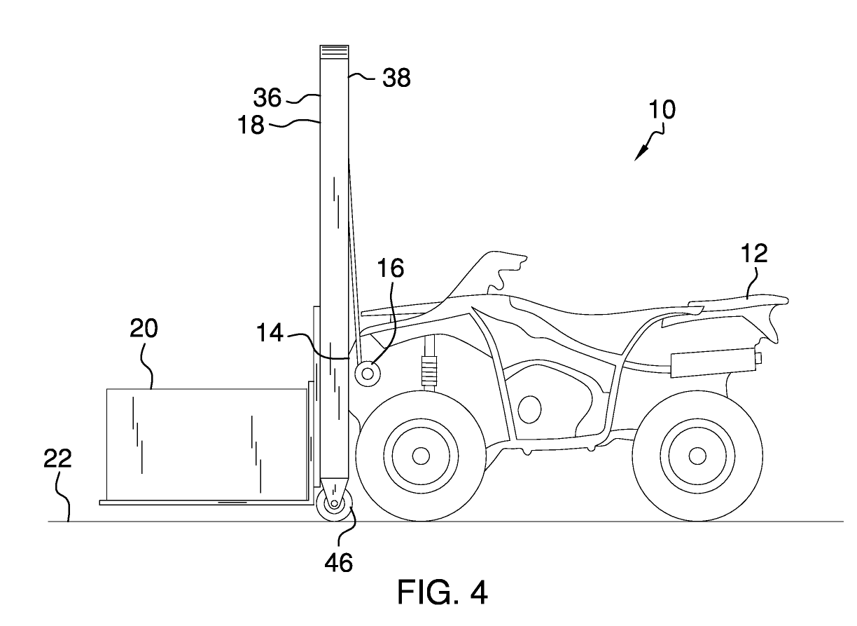

With reference now to the drawings, and in particular to FIGS. 1 through 4 thereof, a new forklift device embodying the principles and concepts of an embodiment of the disclosure and generally designated by the reference numeral 10 will be described.

As best illustrated in FIGS. 1 through 4, the forklift system 10 generally comprises a vehicle 12 that has a front end 14. The vehicle 12 may comprise an ATV or the like. A winch 16 is coupled to the vehicle 12 and the winch 16 is positioned proximate the front end 14. The winch 16 is electrically coupled to the vehicle 12 and the winch 16 is actuatable to rotate in a lifting direction and a lowering direction. The winch 16 may comprise an electric winch that has a functional load capacity ranging between approximately four hundred fifty kg and nine hundred kg.

A forklift 18 is removably coupled to the vehicle 12. The fork lift 18 is positioned on the front end 14 such that the forklift 18 may engage an object 20. Thus, the vehicle 12 may transport the object 20. The forklift 18 is operationally coupled to the winch 16 such that the forklift 18 may selectively lift and lower the object 20 with respect to a support surface 22. The support surface 22 may be ground and the object 20 may have a weight ranging approximately between fifty kg and nine hundred kg.

The forklift 18 comprises a frame 24 that has a mount portion 26 and a lift portion 28. The lift portion 28 includes a pair of longitudinal arms 30, and upper lateral arm 32 and a lower lateral arm 34. Each of the longitudinal arms 30 is coupled to and extends between the upper lateral arm 32 and the lower lateral arm 34. The longitudinal arms 30 are spaced apart from each other.

Each of the longitudinal arms 30 has a forward side 36 and a rearward side 38. The upper lateral arm 32 has a bottom side 40 and the lower lateral arm 34 has a bottom side 42. The mount portion 26 extends away from the rearward side 38 of each of the longitudinal arms 30. The mount portion 26 is positioned proximate the lower lateral arm 34. The mount portion 26 engages the front end 14 of the vehicle 12 such that the frame 24 is removably coupled to the vehicle 12. The mount portion 26 may comprise a plurality of arms 44 or the like and each of the arms 44 may be mechanically coupled to the vehicle 12. Alternatively, the mount portion 26 may comprise any conventional mechanical mount.

A wheel 46 is rotatably coupled to the lower lateral arm 34 and the wheel 46 is positioned on the bottom side 42 of the lower lateral arm 34. The wheel 46 may roll along the support surface 22 when the frame 24 is removably coupled to the vehicle 12. Thus, the wheel 46 transfers a weight of the object 20 into the support surface 22 thereby facilitating the vehicle 12 to transport the weight of the object 20. A pulley 48 is coupled to the upper lateral arm 32 and the pulley 48 is positioned on the bottom side 40 of the upper lateral arm 38. The pulley 48 is centrally positioned between the longitudinal arms 30.

A lift 50 is slidably coupled to the lift portion 28 such that the lift 50 may lift and lower the object 20. The lift 50 comprises a stop 52 that has a frontmost side 54, a rearmost side 56 and a top edge 58. The rearmost side 56 is slidably coupled to the forward side 36 of the frame 24 and the stop 52 travels freely between the upper 32 and lower 34 lateral arms. The stop 52 extends laterally beyond each of the longitudinal arms 30.

A pair of forks 60 is provided and each of the forks 60 has a foot 62 extending away from a leg 64. The leg 64 of each of the forks 60 is slidably coupled to the frontmost side 54 of the stop 52. The foot 62 of each of the forks 60 extends forwardly away from the stop 52. Thus, each of the forks 60 may engage the object 20.

A cable 66 is rollably coupled to the pulley 48. The cable 66 extends between the winch 16 and the top edge 58 of the stop 52. The winch 16 raises the lift 50 when the winch 16 is actuated to rotate in the lifting direction. Thus, the forklift 18 may lift the object 20. The winch 16 lowers the lift 50 when the winch 16 is actuated to rotate in the lowering direction. Thus, the forklift 18 may lower the object 20.

In use, the mount portion 26 is attached to the front end 14 of the vehicle 12. The vehicle 12 is driven the position the forks 60 to engage the object 20. The winch 16 is actuated to rotate in the lifting direction and the forklift 18 urges the object 20 upwardly from the support surface 22. The vehicle 12 is driven to transport the object 20 to a desired location. The winch 16 is actuated to rotate in the lowering direction and the forklift 18 lowers the object 20 onto the support surface 22. The vehicle 12 is driven away from the object 20.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A forklift system comprising:
a vehicle having a front end;
a winch being coupled to said vehicle; and
a forklift being removably coupled to said vehicle, said fork lift being positioned on said front end wherein said forklift is configured to engage an object thereby facilitating said vehicle to transport the object, said forklift being operationally coupled to said winch wherein said forklift is configured to selectively lift and lower the object with respect to a support surface.

2. The system according to claim 1, wherein said winch is positioned proximate said front end, said winch being electrically coupled to said vehicle, said winch being actuatable to rotate in a lifting direction and a lowering direction.

3. The system according to claim 1, wherein said forklift comprises a frame comprising a mount portion and a lift portion, said lift portion including a pair of longitudinal arms, and upper lateral arm and a lower lateral arm, each of said longitudinal arms being coupled to and extending between said upper lateral arm and said lower lateral arm, said longitudinal arms being spaced apart from each other, each of said longitudinal arms having a forward side and a rearward side, said upper lateral arm having a bottom side, said lower lateral arm having a bottom side.

4. The system according to claim 3, wherein said mount portion extends away from said rearward side of each of said longitudinal arms, said mount portion being positioned proximate said lower lateral arm, said mount portion engaging said front end of said vehicle such that said frame is removably coupled to said vehicle.

5. The system according to claim 3, further comprising a wheel being rotatably coupled to said lower lateral arm, said wheel being positioned on said bottom side of said lower lateral arm wherein said wheel is configured to roll along the support surface when said frame is removably coupled to said vehicle thereby facilitating said wheel to transfer a weight of the object into the support surface.

6. The system according to claim 3, further comprising a pulley being coupled to said upper lateral arm, said pulley being positioned on said bottom side of said upper lateral arm, said pulley being centrally positioned between said longitudinal arms.

7. The system according to claim 3, further comprising a lift being slidably coupled to said lift portion wherein said lift is configured to lift and lower the object.

8. The system according to claim 7, wherein said lift comprises a stop having a frontmost side, a rearmost side and a top edge, said rearmost side being slidably coupled to said forward side of said frame, said stop extending laterally beyond each of said longitudinal arms.

9. The system according to claim 8, further comprising a pair of forks, each of said forks having a foot extending away from a leg, said leg of each of said forks being slidably coupled to said frontmost side such that said foot of each of said forks extends forwardly away from said stop wherein each of said forks is configured to engage the object.

10. The system according to claim 1, further comprising:
a pulley;
a stop having a top edge; and
a cable being rollably coupled to said pulley, said cable extending between said winch and said top edge of said stop, said winch raising said lift when said winch is actuated to rotate in a lifting direction wherein said forklift is configured to lift the object, said winch lowering said lift when said winch is actuated to rotate in a lowering direction wherein said forklift is configured to lower the object.

11. A forklift system comprising:
a vehicle having a front end;
a winch being coupled to said vehicle, said winch being positioned proximate said front end, said winch being electrically coupled to said vehicle, said winch being actuatable to rotate in a lifting direction and a lowering direction; and
a forklift being removably coupled to said vehicle, said fork lift being positioned on said front end wherein said forklift is configured to engage an object thereby facilitating said vehicle to transport the object, said forklift being operationally coupled to said winch wherein said forklift is configured to selectively lift and lower the object with respect to a support surface, said forklift comprising:
a frame comprising a mount portion and a lift portion, said lift portion including a pair of longitudinal arms, and upper lateral arm and a lower lateral arm, each of said longitudinal arms being coupled to and extending between said upper lateral arm and said lower lateral arm, said longitudinal arms being spaced apart from each other, each of said longitudinal arms having a forward side and a rearward side, said upper lateral arm having a bottom side, said lower lateral arm having a bottom side, said mount portion extending away from said rearward side of each of said longitudinal arms, said mount portion being positioned proximate said lower lateral arm, said mount portion engaging said front end of said vehicle such that said frame is removably coupled to said vehicle,
a wheel being rotatably coupled to said lower lateral arm, said wheel being positioned on said bottom side of said lower lateral arm wherein said wheel is configured to roll along the support surface when said frame is removably coupled to said vehicle thereby facilitating said wheel to transfer a weight of the object into the support surface,
a pulley being coupled to said upper lateral arm, said pulley being positioned on said bottom side of said upper lateral arm, said pulley being centrally positioned between said longitudinal arms,
a lift being slidably coupled to said lift portion wherein said lift is configured to lift and lower the object, said lift comprising:
a stop having a frontmost side, a rearmost side and a top edge, said rearmost side being slidably coupled to said forward side of said frame, said stop extending laterally beyond each of said longitudinal arms, and
a pair of forks, each of said forks having a foot extending away from a leg, said leg of each of said forks being slidably coupled to said frontmost side such that said foot of each of said forks extends forwardly away from said stop wherein each of said forks is configured to engage the object, and
a cable being rollably coupled to said pulley, said cable extending between said winch and said top edge of said stop, said winch raising said lift when said winch is actuated to rotate in said lifting direction wherein said forklift is configured to lift the object, said winch lowering said lift when said winch is actuated to rotate in said lowering direction wherein said forklift is configured to lower the object.
